(19) United States
(12) Patent Application Publication
(10) Pub. No.: US 2019/0040824 A1
(43) Pub. Date: Feb. 7, 2019

(54) LONG ROUTE-EGR CONNECTION FOR COMPRESSOR INLET SWIRL CONTROL

(71) Applicant: GM Global Technology Operations LLC, Detroit, MI (US)

(72) Inventors: Alberto RACCA, Cavallermaggiore (IT); Riccardo BARIA, Bruino (IT); Andrea TRIPODI, Genova (IT)

(21) Appl. No.: 15/668,687

(22) Filed: Aug. 3, 2017

(51) Int. Cl. F02M 26/17; F02M 26/06; F02B 37/00

(52) U.S. Cl. CPC F02M 26/17; F02B 37/00; F02M 26/06

(57) ABSTRACT

An internal combustion engine includes an engine structure including a plurality of cylinders. An air intake system and an exhaust system are in communication with the plurality of cylinders. A turbocharger includes a turbine section in communication with the exhaust system and a compressor in communication with an air intake passage of the air intake system. The compressor includes a compressor wheel having a predetermined rotational direction during operation. An EGR passage is in communication with the exhaust system and is connected to the air intake passage at a location upstream of the compressor and is tangential to an inner wall of the air intake passage so as to provide a swirl in the predetermined rotational direction.

### FIELD

The present disclosure relates to a turbocharged internal combustion engine having an improved long route-EGR connection for compressor swirl control.

### BACKGROUND

This section provides background information related to the present disclosure which is not necessarily prior art.

Charging systems equipped with compressor inlet-swirl control devices, may present some issues when interactions of air and EGR gas at the long route-EGR connection are considered. In particular, standard long route-EGR layouts present a symmetric lift at the connection point between the EGR and the air paths in front of the compressor. Such standard configuration can deteriorate the controlled inlet swirling motion generated by the inlet-swirl control devices located upstream from the long route EGR connection because of the disturbance induced by the EGR gases on the air side, partially dissipating the desired swirl in the air flow field.

The standard configuration, with symmetric long route EGR connection, can also promote fluid dynamic and psychrometric conditions that may induce higher condensation generation just in front of the compressor rotor, leading to possible durability issues reducing the turbocharger lifetime.

The present disclosure provides a design solution handling both the abovementioned problems and minimizing the disturbance created by the EGR introduction into the main air pipe.

### SUMMARY

This section provides a general summary of the disclosure, and is not a comprehensive disclosure of its full scope or all of its features.

The present disclosure provides a new long route-EGR connection layout integrated in the compressor scroll in front of the rotor. The compressor inlet provide tangential introduction of EGR gases in the air stream through a long route-EGR connection disposed on a side of the compressor inlet.

The connection could be located in any position along the main pipe contour, provided that the EGR flow is introduced into the air stream tangentially to the main pipe inner wall and in the same direction of rotation of the swirling air stream. For instance, if the compressor wheel rotation is counterclockwise, the desired air swirl motion imparted by the tangential EGR port into the compressor inlet would be counterclockwise as well. Therefore, the long route-EGR connection may be placed on the right hand side of the air path in order to eject EGR gases in the main pipe in a tangential/counterclockwise direction.

According to the principles of the present disclosure, an internal combustion engine includes an engine structure including a plurality of cylinders. An air intake system and an exhaust system are in communication with the plurality of cylinders. A turbocharger includes a turbine section in communication with the exhaust system and a compressor in communication with an air intake passage of the air intake system. The compressor includes a compressor wheel having a predetermined rotational direction during operation. An EGR passage is in communication with the exhaust system and is connected to the air intake passage at a location upstream of the compressor and is tangential to the air intake passage so as to provide a swirl in the predetermined rotational direction.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an internal combustion engine having a long route EGR system according to the principles of the present disclosure;

FIG. 2 is a perspective view of a compressor inlet according to the principles of the present disclosure; and

FIG. 3 is a cross-sectional view of the compressor inlet shown in FIG. 2.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

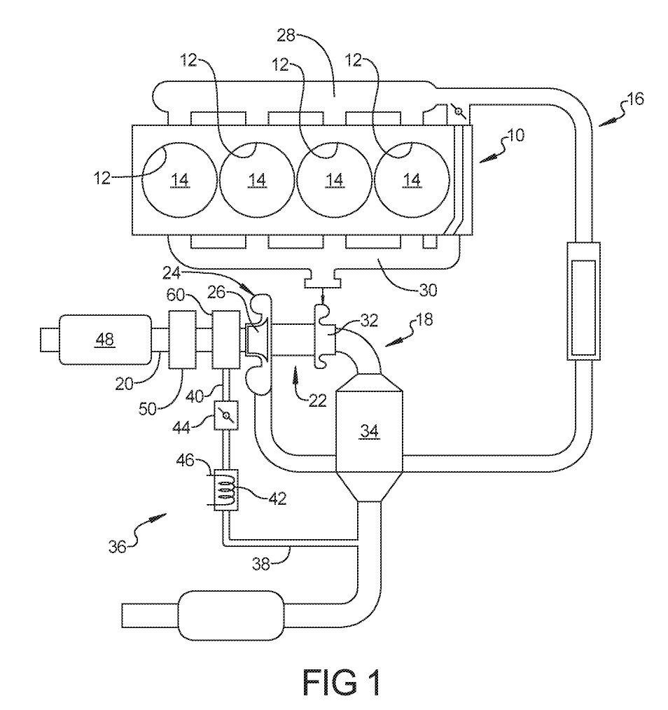

With reference to FIG. 1, an internal combustion engine 10 is shown including a plurality of cylinders 12 each having a working piston 14 disposed therein. The internal combustion engine 10 has an intake system 16 and an exhaust system 18. The intake system 16 includes an air intake passage 20 connected with a turbocharger 22 having a compressor section 24 with a compressor wheel 26 for providing compressed intake air to an intake manifold 28 which is connected to the cylinders 12. The exhaust system 18 includes an exhaust manifold 30 which directs exhaust gasses to a turbine section 32 of the turbocharger 22.

An exhaust gas recirculation (EGR) system 36 is connected between an after treatment system 34 of the exhaust system 18 and the intake system 16 at an inlet of the compressor section 22. The EGR system 36 can include an EGR inlet end 38 and an EGR outlet end 40. The EGR system 36 can include an EGR cooler 42. A flow blending valve 44 can be in disposed in the EGR system 36.

As best shown in FIG. 1, the EGR cooler 42 can include a cooler matrix 46 through which the exhaust gases are directed. The cooler matrix 46 can be liquid cooled.

The air intake system 16 can include an air flow meter 48. A swirling device 50 is provided in the air intake passage 20 to induce a swirl in the intake air in a direction that matches a predetermined swirl direction of the compressor wheel 26 of the compressor section 22.

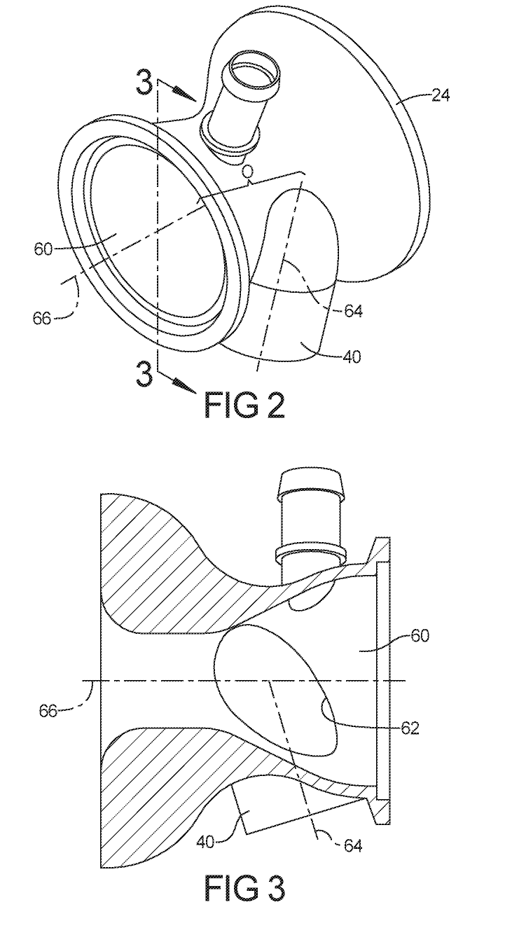

With reference to FIGS. 2 and 3, the EGR outlet end 40 can be connected to a compressor inlet 60 at a location upstream of the compressor section 24. The EGR outlet end 40 defines an opening 62 that has a center axis 64 that is laterally offset by a distance “O” from a center axis 66 of the compressor inlet 60, so that the opening 62 is tangential to the internal wall of the air inlet 60 so as to provide a swirl in the predetermined rotational direction of the compressor wheel 26. Overall, the center axis 64 of the EGR outlet is positioned in order to introduce the EGR flow into the air stream tangentially to the main pipe inner wall and in the same direction of rotation of the swirling air stream.

The inlet configuration with a tangential EGR opening 62 provides condensation protection and compressor performance. The tangential introduction of EGR from the long route circuit 36 into the air intake passage 20 generates favorable fluid dynamic and psychrometric conditions minimizing condensation formation. In case of operations at cold ambient temperature, the condensation avoidance phenomenon is further enhanced and therefore preserves the compressor wheel 26 from poor durability. In case of swirling motion on the air side, the condensation rate at the compressor wheel leading edge is significantly reduced in comparison with the standard central/symmetric EGR connection.

The interaction of the two flows (air and EGR) is minimized by the tangential introduction of EGR into the main stream. Therefore, it's possible to minimize the disturbance on the controlled swirling flow motion generated by a dedicated device 50 located upstream of the long route-EGR connection 36 preserving the desired flow incidence angle at the compressor wheel 26 leading edge Minimizing the disturbance to the incoming air is translated into reduced swirl dissipation. Therefore the pressure drop created by the swirling device to generate such desired swirling flow motion is minimal, minimizing fuel consumption penalties.

The tangential connection of the EGR passage demonstrates to be effective to preserve the desired compressor performance and the machine durability. Moreover it is compatible with any swirling devices, mechanisms or design solution located upstream of the long route-EGR connection.

In addition, in systems not provided with any swirling devices, the tangential introduction of long route-EGR may induce a favorable swirling motion in the air stream approaching the compressor wheel because of the interaction between the two flows at the long route-EGR connection. Even if less effective than in the previous “controlled” case, it's demonstrated that any compressor inlet swirling motion may be beneficial for the machine performance if the swirl rotation is in the correct direction.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An internal combustion engine, comprising:
an engine structure including a plurality of cylinders;
an air intake system in communication with the plurality of cylinders;
an exhaust system in communication with the plurality of cylinders;
a turbocharger including a turbine section in communication with the exhaust system and a compressor in communication with an air intake passage of the air intake system, the compressor including a compressor wheel having a predetermined rotational direction during operation; and
an EGR passage in communication with the exhaust system and connected to the air intake passage at a location upstream of the compressor and tangential to an inner wall of the air intake passage so as to provide a swirl in the predetermined rotational direction.

2. The internal combustion engine according to claim 1, further comprising inlet-swirl control device disposed in the air intake passage upstream of the compressor to induce a swirl in the predetermined rotational direction.

3. An internal combustion engine, comprising:
an engine structure including a plurality of cylinders;
an air intake system in communication with the plurality of cylinders;
an exhaust system in communication with the plurality of cylinders;
a turbocharger including a turbine section in communication with the exhaust system and a compressor section in communication with an air intake passage of the air intake system, the compressor section including a compressor wheel having a predetermined rotational direction during operation; and
an EGR passage in communication with the exhaust system and having an EGR opening that is connected to the air intake passage, the EGR opening having a center axis that is laterally offset relative to an axis of a compressor inlet so as to provide a swirl in the predetermined rotational direction.

4. The internal combustion engine according to claim 3, further comprising inlet-swirl control device disposed in the air intake passage upstream of the compressor to induce a swirl in the predetermined rotational direction.

5. A turbocharger, comprising:
a turbine section including a turbine wheel; and
a compressor section including a compressor wheel having a predetermined rotational direction during operation, wherein the compressor section includes an inlet passage with an EGR opening that is tangential to an inner wall of the inlet passage and adapted to provide a swirl in the predetermined rotational direction.
